(19) United States
(12) Patent Application Publication
(10) Pub. No.: US 2015/0133247 A1
(43) Pub. Date: May 14, 2015

(54) SNOW MOBILE DRIVE ASSEMBLY

(71) Applicant: Shawn Watling, Warsaw (CA)

(72) Inventor: Shawn Watling, Warsaw (CA)

(21) Appl. No.: 14/537,025

(22) Filed: Nov. 10, 2014

Related U.S. Application Data
(60) Provisional application No. 61/903,617, filed on Nov. 13, 2013.

(51) Int. Cl. F16H 57/00; F16H 7/02

(52) U.S. Cl. CPC F16H 57/0037; F16H 7/02
USPC 474/150

(57) ABSTRACT

The present concept is a support arm which connects a drive shaft to a driven shaft, the support arm includes a drive arm includes at one end a drive bearing connected to a drive shaft and the other connecting end is attached to an arm connector. It further includes a driven arm which includes at one end a driven bearing connected to a driven shaft and the other connecting end is attached to the arm connector. The arm connector includes adjusting means for adjustably attaching the driven arm to the arm connector.

This application claims priority from prior provisional application No. 61/903,617, filed on Nov. 13, 2013 by Shawn Watling under title: SNOW MOBILE DRIVE ASSEMBLY

### FIELD OF THE INVENTION

The present concept relates to drive trains used in snow mobiles and other vehicles which are powered by small engines such as all terrain vehicles (ATV's) and golf carts and more particularly relates to stiffening of the primary drive assembly.

### BACKGROUND OF THE INVENTION

Presently drive trains for snow mobiles, ATV's and other small vehicles such as golf carts normally include a drive primary clutch which is connected to the output shaft of a motor and a driven secondary clutch which further transmits power to the drive line of the vehicle.

U.S. Pat. No. 6,561,302 issued on May 13, 2013 and invented by Mr Gerrard Karpik under the title Snowmobile Construction describes a snowmobile drive train and particularly describes the use of a torque arm 310 which is depicted in FIG. 14 of the patent specification. The specification acknowledges that there is an incredible amount of force generated by the drive belt in the drive assembly. In order for the drive belt to be effective it must be placed under tension between the drive pulley and the driven pulley. U.S. Pat. No. 6,561,302 describe the use of a torque arm which is denoted as 310 in the specification to counteract the opposing forces generated by the drive belt as described in column 10 lines 47 to 55 of the specification.

It is known that the stress imparted by the motor can exceed 2100 lbs of tensile load on the drive belt and these tensions must be accommodated by both the drive pulley and the driven pulley without failing.

Modern day snow mobiles, ATV's and other small engine vehicles create so much power that incredible amounts of torque and horse power are transmitted through the drive and driven pulleys so much so that engine torque pulses are transmitted through the drive and driven pulleys to the chassis which results in a significant amount of vibration through the entire chassis of the vehicle. The vibration is so large that there have been reports of the drivers indicating that their hands have become numb due to the vibration transmitted from the drive line through the chassis and up through the handlebars and into the hands of the driver gripping the handlebars.

Therefore there is a need for a mechanism to control and dampen the torque pulsing and vibrations that are increasingly being observed in snowmobiles ATV's and other small engine vehicles due to the increasing amounts of horse power and torque transmitted through their drivelines.

### SUMMARY

The present concept a support arm connecting a drive shaft to a driven shaft, the support arm includes:

a) a drive arm which includes at one end a drive bearing connected to a drive shaft and the other connecting end is attached to an arm connector,

b) a driven arm 118 which includes at one end a driven bearing connected to a driven shaft and the other connecting end is attached to the arm connector,

c) wherein the arm connector includes adjusting means for adjustably attaching the driven arm to the arm connector.

Preferably wherein the arm connector includes a back side for receiving thereon the connecting end of the driven arm.

Preferably wherein the adjusting means includes an outer rail and an inner rail for sandwiching there between with rail bolts the connecting end of driven arm and the back side of the arm connector.

Preferably wherein the connecting end of the driven arm includes adjusting slots wherein the rail bolts pass through the adjusting slots.

Preferably wherein the rails are u shaped rails.

Preferably wherein the arm connector includes a central box section which includes a top side, a bottom side, a front side and a back side.

Preferably wherein the back side for receiving thereon the connecting end of the driven arm.

Preferably wherein the adjusting means includes an outer rail and an inner rail for sandwiching there between with rail bolts the connecting end of driven arm and the back side of the arm connector.

Preferably wherein the connecting end of the driven arm includes adjusting slots wherein the rail bolts pass through the adjusting slots.

Preferably wherein the rails are u shaped rails.

Preferably wherein the front side for receiving thereon the connecting end of the drive arm.

Preferably wherein the connecting end of the drive arm connected to the front side of the arm connector with nuts and bolts which pass through drive arm holes and front holes.

Preferably wherein there are a number of front holes and corresponding drive arm holes which can be used to selectively adjust the length of the support arm.

Preferably wherein the drive arm includes a drive bearing housing for receiving the drive bearing therein and a drive bearing retainer for clamping the drive bearing in the drive bearing housing.

Preferably wherein the driven arm includes a drivenbearing housing for receiving the driven bearing therein and a driven bearing retainer for clamping the driven bearing in the driven bearing housing.

Preferably further including a drive retaining bolt for retaining the drive bearing onto the drive shaft.

Preferably further including a driven retaining bolt for retaining the driven bearing onto the driven shaft.

Preferably further including drive bearing support bushing for receiving the drive bearing on one end and connecting to the drive shaft on the other end.

Preferably further including driven bearing support bushing for receiving the driven bearing on one end and connecting to the driven shaft on the other end.

### BRIEF DESCRIPTION OF THE DRAWINGS

The present concept will now be described by example only with reference to the following drawings in which:

FIG. 1 is a side schematic exploded perspective assembly view of a portion of a snowmobile drive assembly showing the assembly of the primary clutch and the secondary clutch, together with a support arm.

FIG. 2 is a side schematic exploded perspective assembly view of the support arm.

FIG. 3 is a side schematic exploded perspective view of a portion of a snow mobile drive assembly showing the assembly of the primary clutch and secondary clutch together with a support arm for an original equipment installation.

FIG. 4 is a side schematic perspective assembly view of the support arm together with the primary clutch and secondary clutch and a motor showing the motor connected to the drive shaft and the primary clutch and the output through to the driven shaft.

### DETAILED DESCRIPTION OF THE PREFERRED EMBODIMENT

The present concept a snow mobile drive assembly is shown generally as 100 includes an input end 102 which receives power from the motor shaft and transmits this power to a drive pulley 106 which in turn drives drive belt 108 thereby transmitting power to the output end 104 which includes a driven pulley 110 being driven by drive belt 108.

Input end 102 normally includes a primary clutch 112 and output end 104 normally includes a secondary clutch 114.

A very high amount of tension on drive belt 108 causes engine torque pulses and vibrations to be transmitted between drive pulley 106 and driven pulley 110 and through the shaft that is supporting these pulleys. Tension of up to 2100 lbs of load is being transmitted through drive belt 108 due to the great amount of power created by the motor.

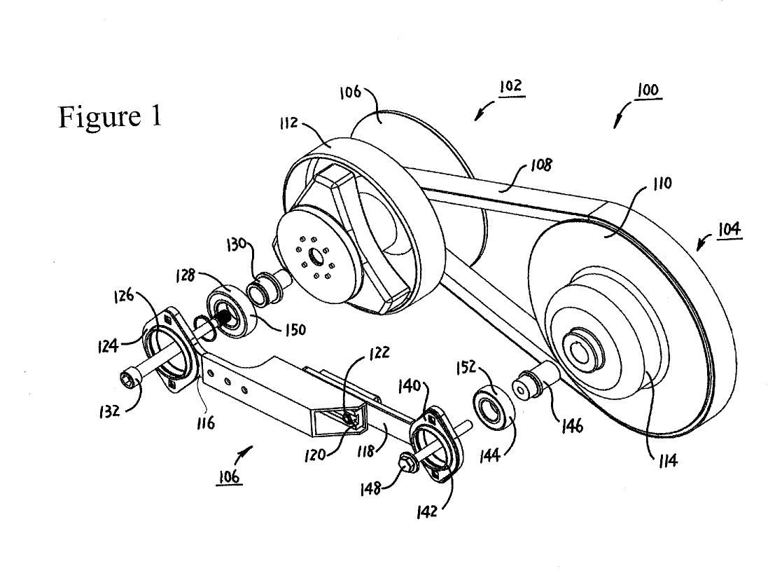

The reader will note that the motor is not shown in FIG. 1 however the output shaft of the motor connects directly to drive pulley 106 at the input end 102.

In order to control the engine torque pulses and vibrations created by the large amount of power being transmitted through drive assembly 100 a support arm 106 has been developed and is connected to the drive assembly 100 as depicted in FIG. 1.

Support arm 106 preferably is a two part arm which includes a drive arm 116 and a driven arm 118. Drive arm 116 includes an adjusting rail 120 and a lock nut 122 for adjusting the longitudinal length of support arm 106 and locking the length in place.

At input end 102 support arm 106 includes a drive flange 124 with a drive bearing housing 126.

A drive bearing 128 is installed into drive bearing housing 126.

A drive bearing support bushing 130 is installed into primary clutch 142 in order to support drive bearing 128.

A drive retaining bolt 132 securely fastens drive flange 124 which includes drive bearing 128 and drive bearing support bushing 130 therein onto primary clutch 112.

Similarly driven arm 118 terminates at driven flange 140 which includes a driven bearing housing 142 for housing therein a driven bearing 144 which is supported by driven bearing support bushing 146.

Driven retaining bolt 148 securely attaches driven arm 118 which includes driven bearing 144 and driven bearing support bushing 146 onto secondary clutch 114. The outside diameter 150 of drive bearing 128 and the outside diameter 152 of driven bearing 144 are spherical diameter bearings to allow for pivoting of the entire support arm 106.

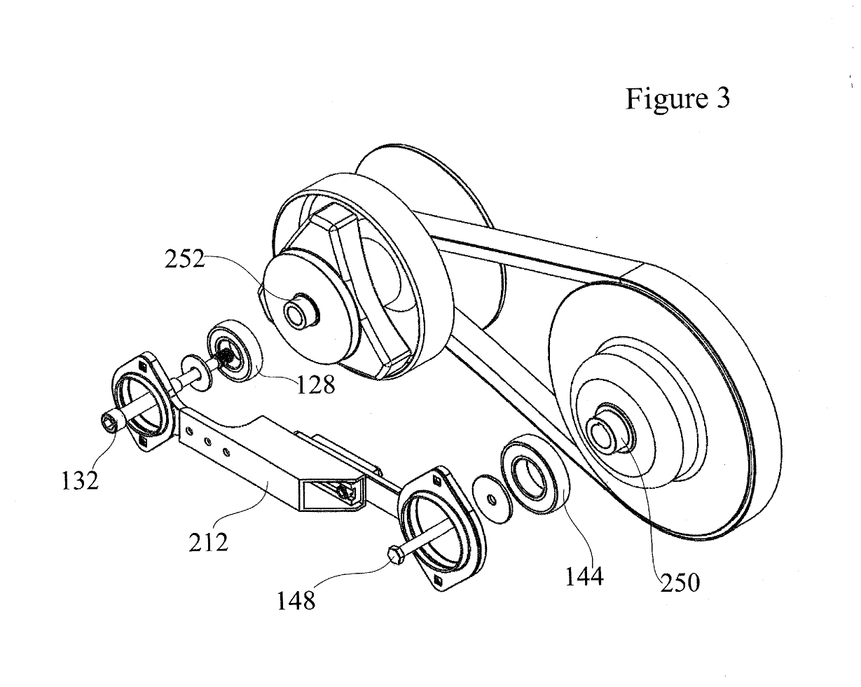

In original equipment arrangements drive bearing 128 at input end 102 is connected and mounted onto drive shaft 252 directly as shown in FIG. 3 eliminating the need for a drive bearing support bushing 130. Similarly driven bearing 144 at output end 104 is connected and mounted driven shaft 250 shown in FIG. 3 eliminating the need for a driven bearing support bushing 146. Support bushings 130 and 146 are required to retrofit existing equipment.

During hard acceleration the amount of tension on drive belt 108 is so great that it tends to cause bending of the motor output shaft and the crank shaft of the engine as well as the jack shaft at the driven pulley 110. The support arm 106 minimizes this bending and avoids catastrophic failure of either breaking of the main motor output shaft and/or crank shaft and/or the jack shaft.

The amount of bending and vibration that is being transmitted through the motor shaft connected to drive pulley 106 and a jack shaft which is normally connected to driven pulley 110 is so great that failure of either to motor shaft and/or the jack shaft has been observed in practice.

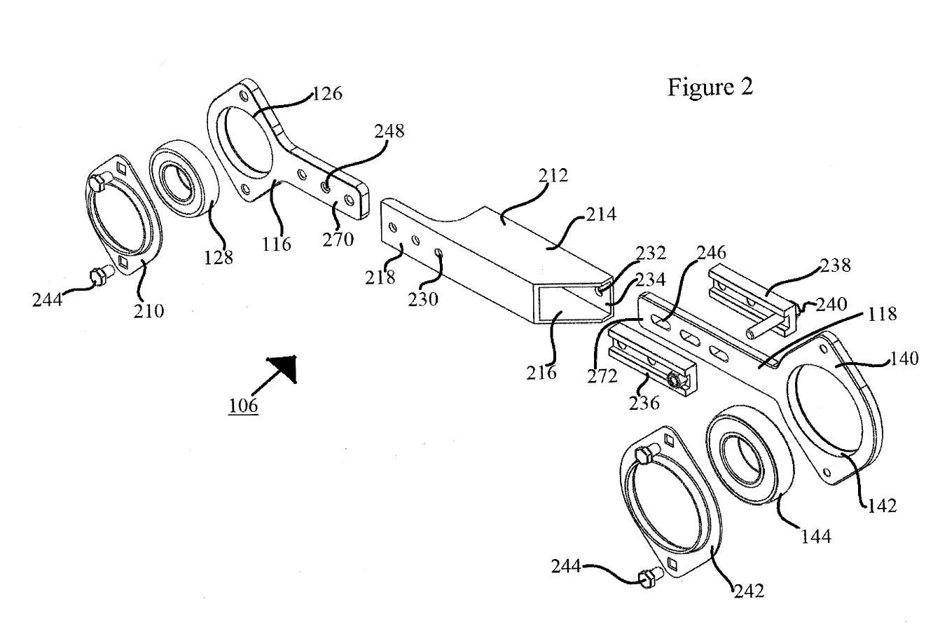

Referring now to FIG. 2 which shows in exploded perspective fashion a support arm 106 which includes the following components namely drive arm 116, arm connector 212 and driven arm 118.

Arm connector 212 includes central box section which has a top side 214, a bottom side 216 , a front side 218 having front holes 230 and a back side 234 which includes back holes 232.

Driven arm 118 includes a connecting end 272 with adjusting slots 246 which register with back holes 232 of back side 234 and are clamped together using inner rail 236 and outer rail 238 together with rail bolts 240 in order to clamp driven arm 118 onto back side 234 of arm connector 212.

Drive arm 116 includes a connecting end 270 which has drive arm holes 248 which register with front holes 230 in front side 218 of arm connector 212. Bolts not shown are used to connect drive arm 116 to the front side of arm connector 212.

A drive bearing retainer 210 is used to mount drive bearing 128 into drive bearing housing 126 using retainer bolts 244. Similarly driven bearing retainer 242 is used to retain driven bearing 144 in driven bearing housing 142 of drive arm 118.

Referring now to FIG. 3 which is similar to FIG. 1 except that it does not include drive bearing support bushing 130 and driven bearing support bushing 146 since FIG. 3 shows an original equipment insulation.

Instead in FIG. 3 drive bearing 128 is mounted directly onto drive shaft 252 and driven bearing 144 is mounted directly onto driven shaft 250 and held in place with drive retaining bolt 132 and driven retaining bolt 148 as depicted in FIG. 3. In this manner one able to eliminate the adapters namely drive bearing support bushing 130 and driven bearing support bushing 146 which essentially adapt any existing drive arrangement for mounting of support arm 106 thereon.

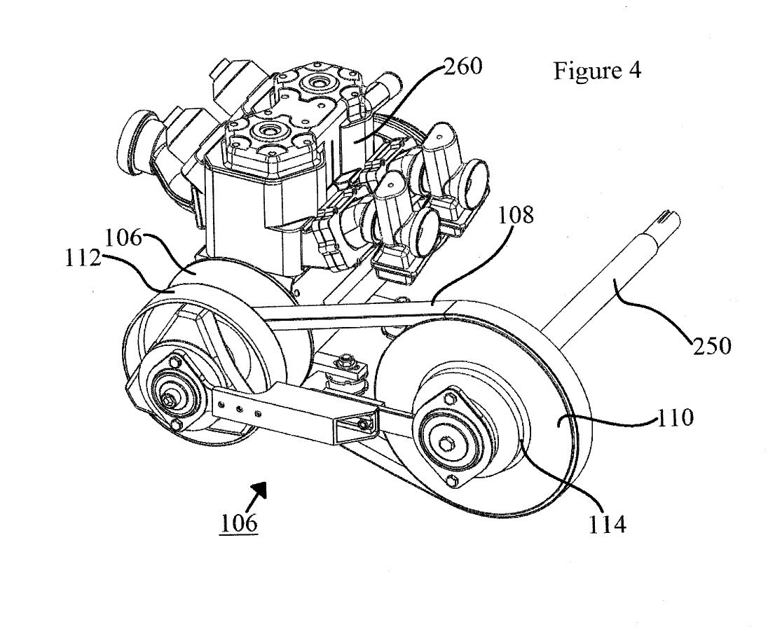

Finally FIG. 4 shows in schematic fashion a drive assembly which includes a motor which drive a drive belt 108 via a primary clutch 112 and a secondary clutch 114 through a drive pulley 106 and a driven pulley 110.

Support arm 106 is shown assembled and bolted onto the primary clutch 112 on the drive end and onto secondary clutch 114 and driven pulley 110 on the driven end which outputs through driven shaft 250.

It should be apparent to persons skilled in the arts that various modifications and adaptation of this structure described above are possible without departure from the spirit of the invention the scope of which defined in the appended claim.

I claim:

1. A support arm connecting a drive shaft to a driven shaft, the support arm includes:
d) a drive arm which includes at one end a drive bearing connected to a drive shaft and the other connecting end is attached to an arm connector,
e) a driven arm 118 which includes at one end a driven bearing connected to a driven shaft and the other connecting end is attached to the arm connector,
f) wherein the arm connector includes adjusting means for adjustably attaching the driven arm to the arm connector.

2. The support arm claimed in claim 1 wherein the arm connector includes a back side for receiving thereon the connecting end of the driven arm.

3. The support arm claimed in claim 2 wherein the adjusting means includes an outer rail and an inner rail for sandwiching there between with rail bolts the connecting end of driven arm and the back side of the arm connector.

4. The support arm claimed in claim 3 wherein the connecting end of the driven arm includes adjusting slots wherein the rail bolts pass through the adjusting slots.

5. The support arm claimed in claim 3 wherein the rails are u shaped rails.

6. The support arm claimed in claim 1 wherein the arm connector includes a central box section which includes a top side, a bottom side, a front side and a back side.

7. The support arm claimed in claim 6 wherein the back side for receiving thereon the connecting end of the driven arm.

8. The support arm claimed in claim 7 wherein the adjusting means includes an outer rail and an inner rail for sandwiching there between with rail bolts the connecting end of driven arm and the back side of the arm connector.

9. The support arm claimed in claim 8 wherein the connecting end of the driven arm includes adjusting slots wherein the rail bolts pass through the adjusting slots.

10. The support arm claimed in claim 8 wherein the rails are u shaped rails.

11. The support arm claimed in claim 7 wherein the front side for receiving thereon the connecting end of the drive arm.

12. The support arm claimed in claim 1 wherein the connecting end of the drive arm connected to the front side of the arm connector with nuts and bolts which pass through drive arm holes and front holes.

13. The support arm claimed in claim 1 wherein there are a number of front holes and corresponding drive arm holes which can be used to selectively adjust the length of the support arm.

14. The support arm claimed in claim 1 wherein the drive arm includes a drive bearing housing for receiving the drive bearing therein and a drive bearing retainer for clamping the drive bearing in the drive bearing housing.

15. The support arm claimed in claim 1 wherein the driven arm includes a drivenbearing housing for receiving the driven bearing therein and a driven bearing retainer for clamping the driven bearing in the driven bearing housing.

16. The support arm claimed in claim 14 further including a drive retaining bolt for retaining the drive bearing onto the drive shaft.

17. The support arm claimed in claim 14 further including a driven retaining bolt for retaining the driven bearing onto the driven shaft.

18. The support arm claimed in claim 1 further including drive bearing support bushing for receiving the drive bearing on one end and connecting to the drive shaft on the other end.

19. The support arm claimed in claim 1 further including driven bearing support bushing for receiving the driven bearing on one end and connecting to the driven shaft on the other end.
